(19) United States
(12) Patent Application Publication
(10) Pub. No.: US 2025/0153479 A1
(43) Pub. Date: May 15, 2025

(54) CURVED STRUCTUAL GLAZING COMPOSITE FORMED VIA COLD BENDING WITH IMPROVED DURABILITY

(71) Applicants: DOW SILICONES CORPORATION, Midland, MI (US); DOW GLOBAL TECHNOLOGIES LLC, Midland, MI (US)

(72) Inventors: Jie FENG, Midland, MI (US); Mark MIRGON, Midland, MI (US); Jon KIMBERLAIN, Elizabethtown, KY (US); Sigurd SITTE, Wiesbaden (DE); Valérie HAYEZ, Seneffe (BE)

(21) Appl. No.: 18/725,702

(22) PCT Filed: Dec. 28, 2022
(86) PCT No.: PCT/US2022/054169

§ 371 Date: Jun. 28, 2024

Related U.S. Application Data
(60) Provisional application No. 63/295,549, filed on Dec. 31, 2021.

(51) Int. Cl. B32B 38/00; B32B 1/00; B32B 3/04; B32B 3/30; B32B 7/12; B32B 17/06; B32B 37/12

(52) U.S. Cl. CPC B32B 38/0012; B32B 1/00; B32B 3/04; B32B 3/30; B32B 7/12; B32B 17/061; B32B 37/1284; B32B 2037/1253; B32B 2250/02; B32B 2307/7376; B32B 2309/02; B32B 2309/105; B32B 2383/00; B32B 2419/00

(57) ABSTRACT

A method of preparing a curved structural glazing composite comprises providing an initial composite comprising a metal frame and a glass panel with a silicone sealant disposed therebetween and cold bending the initial composite to give the curved structural glazing composite. A ratio of a thickness of the metal frame to a thickness of the silicone sealant in the curved structural glazing composite is less than 10.

### CROSS REFERENCE TO RELATED APPLICATIONS

This application claims the benefit of U.S. Provisional Application No. 63/295,549, filed Dec. 31, 2021, the disclosure of which is incorporated by reference in its entirety.

### FIELD OF THE INVENTION

The present disclosure relates generally to cold bent glass and, more specifically, to a curved structural glazing composite, a method of preparing the curved structural glazing composite, and a building including the curved structural glazing composite.

### DESCRIPTION OF THE RELATED ART

Modern construction has increasingly utilized free form (curved) glass façades in building architecture. Structural sealant glazing (SSG), for example, involves the use of large glass panels that are integral to the design of a building. The glass panels are bonded back to a support structure such as an aluminum frame using a silicone sealant. The glass panels are then bent into the desired curved shape. Cold bending and hot bending are two methods of forming the bent glass panels. Cold bending processes are more cost efficient than hot bending processes. In cold bending, a flat glass panel (either monolithic glass or laminated glass) is bonded to a metal frame by a silicone sealant, and then elastically deformed without the application of heat to follow the desired façade contours.

Unlike hot bending processes, cold bending imposes a permanent bending force onto the silicone sealant as the bent glass naturally attempts to return to its initial flat shape, stressing the sealant joint. Thus, two technical challenges in cold bent glass applications using silicone structural sealant are silicone sealant creep and silicone sealant tear failure. Silicone sealant creep is driven by the relaxation of silicone sealant under constant load, and it increases proportionally in relation to the initial strain applied onto the silicone sealant during the cold bending operation. Sealant creep can lead to deformation of the cold bent glass structure. Tear failure can occur in the silicone sealant after the cold bending operation. Sealant tear failure is caused by an excessive maximum principal strain inside the sealant layer, and is directed related to the durability (i.e. longevity) of the cold bent glass structure. Minimizing sealant creep and tear failure are therefore important to increasing the service life of cold bent glass structures.

### BRIEF SUMMARY

The present disclosure provides a method of preparing a curved structural glazing composite. The method comprises providing an initial composite comprising a metal frame and a glass panel with a silicone sealant disposed therebetween. The method further comprises cold bending the initial composite to give the curved structural glazing composite. A ratio of a thickness of the metal frame to a thickness of the silicone sealant in the curved structural glazing composite is less than 10.

In specific embodiments, cold bending is carried out without the application of heat.

In particular embodiments, the metal frame defines an internal cavity, and the ratio of a thickness of the metal frame to a thickness of the silicone sealant is less than 7.

In particular embodiments, the ratio of a thickness of the metal frame to a thickness of the silicone sealant is less than 4.

In particular embodiments, the metal frame and the silicone sealant are continuous about a perimeter of the glass panel and define an internal gap adjacent the glass panel.

In particular embodiments, the silicone sealant is only disposed along a portion of the perimeter of the glass panel.

In particular embodiments, the method further includes preparing the initial composite by sandwiching a silicone sealant composition between the metal frame and the glass panel and curing the silicone sealant composition to give the silicone sealant and the initial composite.

In particular embodiments, the metal frame defines a plurality of substantially parallel grooves oriented in a direction transverse to the direction that the initial composite is bent, and the grooves are located on a side of the metal frame opposite of the silicone sealant.

In particular embodiments, the grooves are configured to reduce peak maximum principal strain in the silicone sealant by at least 8 percentage points.

In particular embodiments, the method further includes calculating a correlation between the peak maximum principal strain and the durability of the silicone sealant of the curved structural glazing composite.

In certain embodiments, the peak maximum principal strain is less than 35%.

A curved structural glazing composite formed in accordance with the method is also provided, along with a building comprising the curved structural glazing composite. The curved structural glazing composite includes a metal frame and a glass panel with a silicone sealant disposed therebetween. A ratio of a thickness of the metal frame to a thickness of the silicone sealant is less than 10.

### DESCRIPTION OF THE DRAWINGS

Various advantages and aspects of this disclosure may be understood in view of the following detailed description when considered in connection with the accompanying drawings, wherein:

FIG. 1 shows a partial perspective view of an initial structural glazing composite in accordance with some embodiments of the disclosure;

FIG. 2 shows a partial perspective view of another initial structural glazing composite in accordance with particular embodiments of the disclosure;

FIG. 3 shows a partial perspective view of yet another initial structural glazing composite in accordance with particular embodiments of the disclosure;

FIG. 4 shows a schematic view of an actual frame section and an equivalent modeled, simplified frame section in accordance with some embodiments of the disclosure;

FIG. 5 shows a side view of an initial structural glazing composite subjected to cold bending deflection in accordance with some embodiments of the disclosure;

FIG. 6 shows a perspective view of a curved structural glazing composite obtained by cold bending deflection in accordance with some embodiments of the disclosure;

FIG. 7 shows a partial perspective view of an initial structural glazing composite having a baseline (high) thickness ratio of a metal frame to a silicone sealant;

FIG. 8 shows a partial perspective view of an initial structural glazing composite having an improved thickness ratio of a metal frame to a silicone sealant in accordance with particular embodiments of the disclosure;

FIG. 9 shows a partial perspective view of another initial structural glazing composite having an improved thickness ratio of a metal frame to a silicone sealant in accordance with particular embodiments of the disclosure;

FIG. 10 shows a schematic view of the location of a neutral plane in a curved structural glazing composite having a baseline (high) thickness ratio of a metal frame to a silicone sealant;

FIG. 11 shows a schematic view of the location of a neutral plane in a curved structural glazing composite having an improved thickness ratio of a metal frame to a silicone sealant in accordance with some embodiments of the disclosure;

FIG. 12 shows a schematic view of strain in an x-y coordinate system and strain transformed into principal direction;

FIG. 13 shows a main effect plot for a curved structural glazing composite in accordance with particular embodiments of the disclosure;

FIG. 14 shows a graph of peak strain in a silicone sealant as a function of a thickness ratio of a metal frame to the silicone sealant for the curved structural glazing composite of FIG. 13;

FIG. 15 shows a graph of durability of silicone sealant as a function of thickness ratio of a metal frame to a silicone sealant for the curved structural glazing composite of FIG. 13;

FIG. 16 shows another main effect plot for a curved structural glazing composite in accordance with particular embodiments of the disclosure;

FIG. 17 shows a graph of peak strain in the silicone sealant as a function of a thickness ratio of a metal frame to a silicone sealant for the curved structural glazing composite of FIG. 16;

FIG. 18 shows a graph of durability of a silicone sealant as a function of a thickness ratio of a metal frame to the silicone sealant for the curved structural glazing composite of FIG. 16;

FIG. 19 shows a perspective view of an initial structural glazing composite in accordance with particular embodiments of the disclosure;

FIG. 20 shows a partial side view of an initial structural glazing composite in accordance with certain embodiments of the disclosure;

FIG. 21 shows a partial side view of another initial structural glazing composite in accordance with certain embodiments of the disclosure;

FIG. 22 shows a partial side view of yet another initial structural glazing composite in accordance with certain embodiments of the disclosure;

FIG. 23 shows a graph of peak strain as a function of groove depth in accordance with particular embodiments of the disclosure;

FIG. 24 shows a graph of durability as a function of groove depth in accordance with particular embodiments of the disclosure;

FIG. 25 shows a graph of peak strain in a silicone sealant for certain groove chamfer designs in accordance with particular embodiments of the disclosure; and

FIG. 26 shows a graph of peak stress in a metal frame for certain groove chamfer designs in accordance with particular embodiments of the disclosure.

### DETAILED DESCRIPTION

A method of preparing a curved structural glazing composite (the “curved composite”) and the curved composite formed thereby is provided herein. As will be understood from the description herein, the curved composite provides for improved durability of a silicone sealant bond between a glass panel and a metal frame of the curved composite. The curved composite reduces both sealant creep (deformation of the silicone sealant in the curved composite) as well as sealant tear failure in the curved composite. The curved composite may therefore have an increased longevity as compared to conventional curved structural glazing composites formed via a cold bending process.

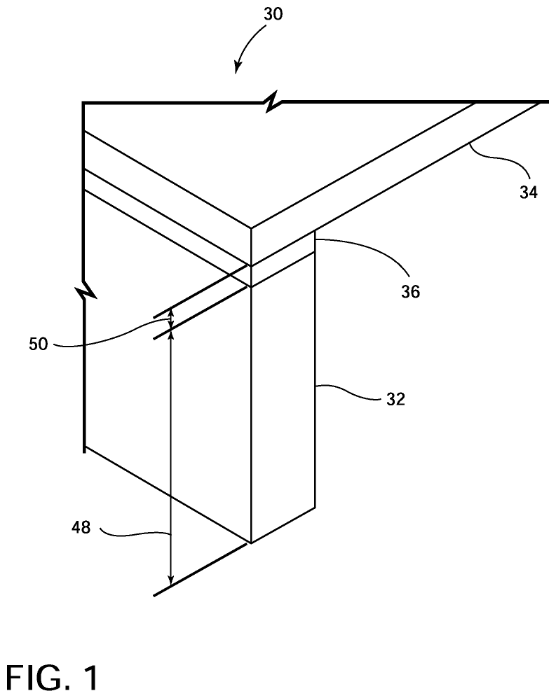

As shown in FIG. 1, the method involves an initial structural glazing composite (the “initial composite”) 30 comprising a metal frame 32, a glass panel (e.g. a glass plate) 34, and a silicone sealant 36 as a bonding layer sandwiched between the metal frame and the glass panel. The initial composite 30 is structurally identical to the curved composite 38 (see FIG. 6) but for the curved nature of the curved composite imparted by the cold bending process. Said differently, both of the initial composite 30 and the curved composite 38 comprise the metal frame 32, the glass panel 34, and the silicone sealant 36 as the bonding layer sandwiched between the metal frame and the glass panel. As such, any description herein relating to the initial composite 30 also applies to the curved composite 38, and vice versa, with the exception of the curved nature of the curved composite. Typically, the initial composite 30 is planar and free from any curves. However, in other embodiments, the initial composite may be non-planar so long as the method imparts a curve to give the curved composite. A plurality of the glazing composite components may form a unitized system, which is a preassembled, panelized metal framing system that is typically shop-glazed, with the panels being transported to a construction site for erection on a building structure.

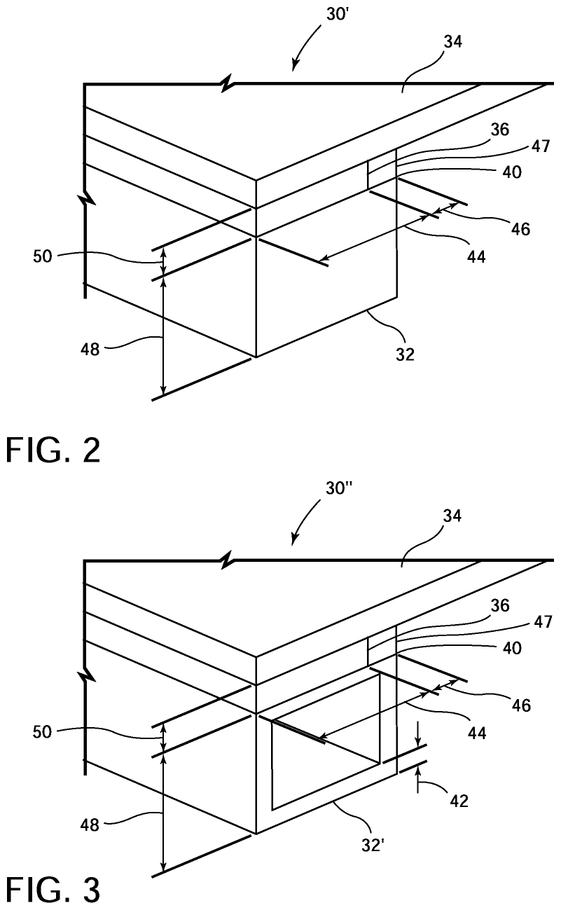

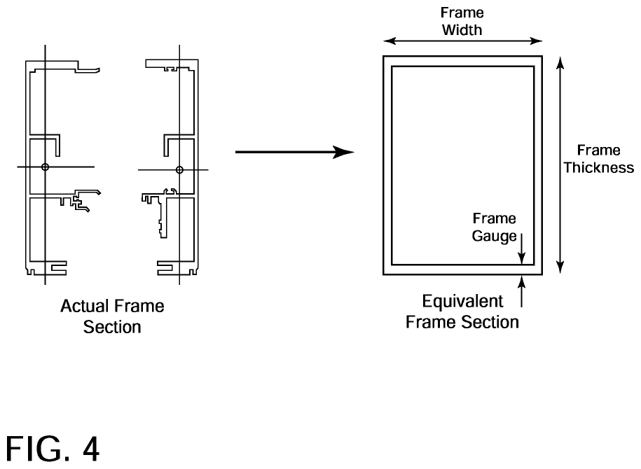

The metal frame 32 may be made primarily of aluminum, although the metal frame is not limited to aluminum and may include other metals or alloys or may be made primarily of another metal. The metal frame 32 also may have either a solid cross-section as shown in the initial composite 30′ of FIG. 2 or alternatively may be hollow wherein the metal frame 32′ has a frame gauge 42 defines an internal cavity as shown in the initial composite 30″ of FIG. 3. Typically, the metal frame may have a complex geometry. However, the dimensions of the real frame section can be simplified into an equivalent frame section that has a simple rectangular frame shape having a length, width, and gauge as shown in FIG. 4. The glass panel 34 is bonded onto the metal frame 32 by the silicone sealant 36. The glass panel 34 may be monolithic, or may comprise a laminated glass. The glass panel 34 is not limited and may comprise silicate glass, soda-lime glass, borosilicate glass, aluminosilicate glass, germanium-oxide glass, annealed glass, float glass, architectural glass, tempered glass, window glass, glazing glass, etc.

The metal frame 32, 32′ and the silicone sealant 36 may be continuous along a perimeter of the glass panel 34 and may define an internal gap 40 adjacent the glass panel as shown in FIGS. 2 and 3. The gap allows for visibility through the initial composite, which can serve as a window. Alternatively, the silicone sealant may only be disposed along a portion of the perimeter of the glass panel, and other portions of the glass panel may be mechanically retained/connected to the metal frame (not shown). The silicone sealant 36 may therefore extend from an outer edge of the frame a certain width 44 such that a width 46 of the frame 32, 32′ is not covered with sealant. In addition, typically a spacer member 47 such as a gasket or foam tape occupies the width 46 where silicone sealant 36 is not present. More specifically, the gasket or foam tape is placed on the fame 32, 32′ and/or disposed between the frame and the glass panel 34 to define the area in which the silicone sealant 36 is injected to form the initial composite 30′, 30″.

The initial composite 30, 30′, 30″ may be obtained commercially or, in other embodiments, the method further comprises forming or preparing the initial composite. The initial composite is typically formed by sandwiching a silicone sealant composition between the metal frame and the glass panel and curing the silicone sealant composition to give the silicone sealant and the initial composite. By way of example, the silicone sealant composition is typically applied on the metal frame, and the glass panel is disposed on the silicone sealant composition to sandwich the silicone sealant composition between the metal frame and the glass panel. In other embodiments, however, the silicone sealant composition may be disposed on the glass panel, with the metal frame disposed on the silicone sealant composition to sandwich the silicone sealant composition between the metal frame and the glass panel. The order of addition with respect to preparing the initial composite is not limited.

In some embodiments, the silicone sealant composition is cured after being sandwiched between the metal frame and the glass panel, to form the initial composite prior to cold bending. However, the silicone sealant composition can be cured contemporaneously with cold bending the initial composite and/or after cold bending the initial composite. Further still, the silicone sealant composition may initiate cure prior to cold bending the initial composite, and continue to cure throughout any step of the method of preparing the curved composite.

In certain embodiments, the silicone sealant composition comprises a condensation-curable silicone composition.

The condensation-curable silicone composition typically comprises (A) an organopolysiloxane having an average of at least two silicon-bonded hydroxyl or hydrolysable groups per molecule; optionally (B) an organosilicon compound having an average of at least two silicon-bonded hydrogen atoms, hydroxyl groups, or hydrolysable groups per molecule; and (C) a condensation catalyst. Although any parameter or condition may be selectively controlled during the inventive method or any individual step thereof, relative humidity and/or moisture content of ambient conditions may be selectively controlled to further impact a cure rate of condensation-curable silicone compositions.

The organopolysiloxane (A) and the organosilicon compound (B) may independently be linear, branched, cyclic, or resinous. In particular, the organopolysiloxane (A) and the organosilicon compound (B) may comprise any combination of M, D, T, and Q units. The symbols M, D, T, and Q represent the functionality of structural units of organopolysiloxanes. M represents the monofunctional unit R⁰₃SiO_{1/2}. D represents the difunctional unit R⁰₂SiO_{2/2}. T represents the trifunctional unit R⁰SiO_{3/2}. Q represents the tetrafunctional unit SiO_{4/2}. Generic structural formulas of these units are shown below:

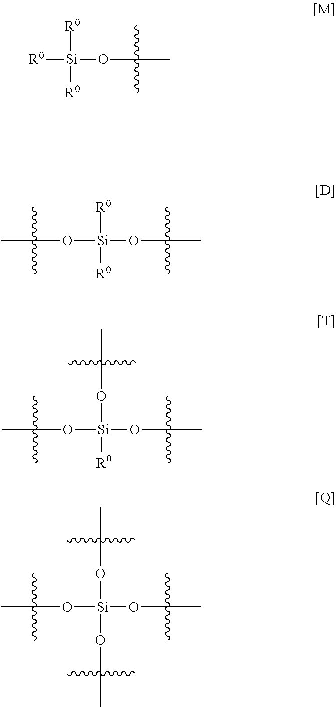

In these structures/formulae, each R⁰ may be any hydrocarbon, aromatic, aliphatic, alkyl, alkenyl, or alkynl group.

The particular organopolysiloxane (A) and organosilicon compound (B) may be selected based on desired properties of the silicone sealant.

For example, in certain embodiments, one of the organopolysiloxane (A) and the organosilicon compound (B) comprises a silicone resin, which typically comprises T and/or Q units in combination with M and/or D units. When the organopolysiloxane (A) and/or organosilicon compound (B) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the condensation-curable silicone composition comprises a resin, the silicone sealant has increased rigidity.

Alternatively, in other embodiments, the organopolysiloxane (A) and/or the organosilicon compound (B) is an organopolysiloxane comprising repeating D units. Such organopolysiloxanes are substantially linear but may include some branching attributable to T and/or Q units. Alternatively, such organopolysiloxanes are linear. In these embodiments, the silicone sealant is elastomeric.

The silicon-bonded hydroxyl groups and silicon-bonded hydrogen atoms, hydroxyl groups, or hydrolysable groups of the organopolysiloxane (A) and the organosilicon compound (B), respectively, may independently be pendent, terminal, or in both positions.

As known in the art, silicon-bonded hydroxyl groups result from hydrolyzing silicon-bonded hydrolysable groups. These silicon-bonded hydroxyl groups may condense to form siloxane bonds with water as a byproduct.

Examples of hydrolysable groups include the following silicon-bonded groups: H, a halide group, an alkoxy group, an alkylamino group, a carboxy group, an alkyliminoxy group, an alkenyloxy group, or an N-alkylamido group. Alkylamino groups may be cyclic amino groups.

In a specific embodiment, the organopolysiloxane (A) has the general formula:

(R¹R³₂SiO_{1/2})_{w}(R³₂SiO_{2/2})ₓ(R³SiO_{3/2})_{y}(SiO_{4/2})_{z} (II)

wherein each R¹ is defined above and each R³ is independently selected from R¹ and a hydroxyl group, a hydrolysable group, or combinations thereof with the proviso that at least two of R³ are hydroxyl groups, hydrolysable groups, or combinations thereof, and w, x, y, and z are mole fractions such that w+x+y+z=1. As understood in the art, for linear organopolysiloxanes, subscripts y and z are generally 0, whereas for resins, subscripts y and/or z>0. Various alternative embodiments are described below with reference to w, x, y and z. In these embodiments, the subscript w may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x typically has a value of from 0 to 0.9, alternatively from 0 to 0.45, alternatively from 0 to 0.25. The subscript y typically has a value of from 0 to 0.99, alternatively from 0.25 to 0.8, alternatively from 0.5 to 0.8. The subscript z typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

As set forth above, the condensation-curable silicone composition further comprises the organosilicon compound (B). The organosilicon compound (B) may be linear, branched, cyclic, or resinous. In one embodiment, the organosilicon compound (B) has the formula R¹_{q}Six_{4-q}, wherein R¹ is defined above, X is a hydrolysable group, and q is 0 or 1.

Specific examples of organosilicon compounds (B) include alkoxy silanes such as MeSi(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)3, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH_{2═}CHSi[O—N=C(CH₃)CH₂CH₃]₃; organoacetamidosilanes such as CH₃Si[NHC(═O)CH₃]₃ and C₆H₅Si[NHC(═O)CH₃]₃; amino silanes such as CH₃Si[NH(C₄H₉)]₃ and CH₃Si(NHC₆H₁₁)₃; and organoaminooxysilanes.

The organosilicon compound (B) can be a single organosilicon compound or a mixture of two or more different organosilicon compounds, each as described above. Also, methods of preparing organosilicon compounds are well known in the art; many organosilicon compounds are commercially available.

When present, the concentration of the organosilicon compound (B) in the condensation-curable silicone composition is sufficient to cure (cross-link) the organopolysiloxane (A). The particular amount of the organosilicon compound (B) utilized depends on the desired extent of cure, which generally increases as the ratio of the number of moles of silicon-bonded hydrolysable groups in the organosilicon compound (B) to the number of moles of silicon-bonded hydroxy groups in the organopolysiloxane (A) increases. The optimum amount of the organosilicon compound (B) can be readily determined by routine experimentation.

The condensation catalyst (C) can be any condensation catalyst typically used to promote condensation of silicon-bonded hydroxy (silanol) groups to form Si—O—Si linkages. Examples of condensation catalysts include, but are not limited to, amines; and complexes of lead, tin, zinc, and iron with carboxylic acids. In particular, the condensation catalyst (C¹) can be selected from tin (II) and tin (IV) compounds such as tin dilaurate, tin dioctoate, and tetrabutyl tin; and titanium compounds such as titanium tetrabutoxide.

When present, the concentration of the condensation catalyst (C) is typically from 0.1 to 10% (w/w), alternatively from 0.5 to 5% (w/w), alternatively from 1 to 3% (w/w), based on the total weight of the organopolysiloxane (A) in the condensation-curable silicone composition.

When the condensation-curable silicone composition includes the condensation catalyst (C), the condensation-curable silicone composition is typically a two-part composition where the organopolysiloxane (A) and condensation catalyst (C) are in separate parts. In this embodiment, the organosilicon compound (B) is typically present along with the condensation catalyst (C). Alternatively still, the condensation-curable silicone composition may be a three-part composition, where the organopolysiloxane (A), the organosilicon compound (B) and condensation catalyst (C) are in separate parts.

Solidification conditions for such condensation-curable silicone compositions may vary. For example, condensation-curable silicone composition may be solidified or cured upon exposure to ambient conditions and/or heat, although heat is commonly utilized to accelerate solidification and curing.

In specific embodiments, the silicone sealant composition comprises a room temperature vulcanizable (RTV) silicone compositions (hereinafter referred to as “RTV compositions”). Generally, such RTV compositions are condensation-curable and comprise an —OH end-blocked diorganopolysiloxane polymer or an alkoxy end-blocked polydiorganosiloxane which may have an alkylene link between the end silicon atoms and one or more suitable cross-linking agents designed to react with the —OH and/or alkoxy groups and thereby cross-link the composition to form an elastomeric sealant product. One or more additional ingredients such as catalysts, reinforcing fillers, non-reinforcing fillers, diluents (e.g. plasticisers and/or extenders), chain extenders, flame retardants, solvent resistant additives, biocides and the like are often also incorporated into these compositions as and when required. They may be one-part compositions or multiple-part compositions. One-part compositions are generally stored in a substantially anhydrous form to prevent premature cure. In certain embodiments, the primary, if not sole, source of moisture in these compositions are the inorganic fillers, e.g. silica when present. Such fillers may be rendered anhydrous before inter-mixing with other ingredients or water/moisture may be extracted from the mixture during the mixing process to ensure that the resulting silicone sealant composition is substantially anhydrous. RTV silicone compositions are advantageous for the silicone sealant composition given that no discrete or external curing condition, e.g. heat, is necessary to cure. As such, when the silicone sealant composition comprises the RTV composition, no curing condition need be applied to form the silicone sealant from the silicone sealant composition.

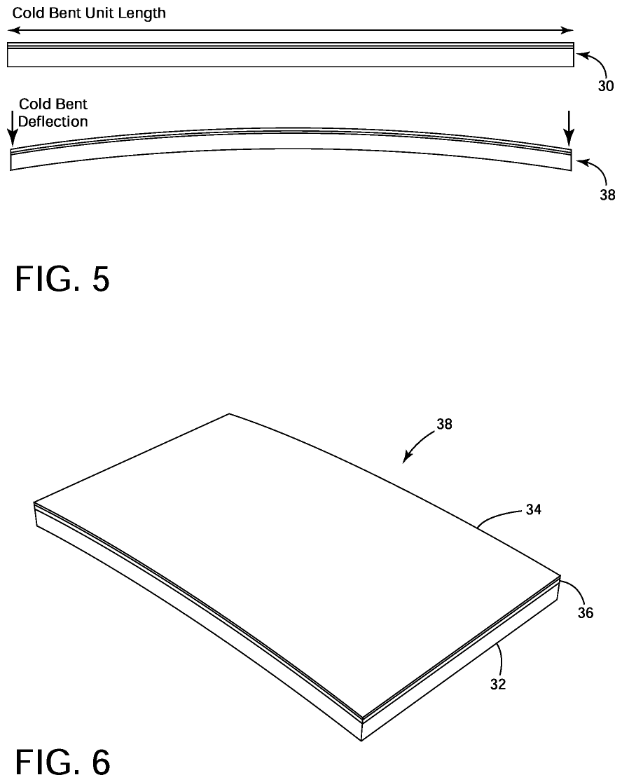

The method comprises cold bending the initial composite. In certain embodiments, cold bending is carried out in the absence of any application of heat, e.g. from an external heat source. In particular, the method involves a cold bending process as distinguished from a hot bending process, as known in the art. Cold bending is typically carried out at natural room or ambient temperature (i.e. without the application of heat energy from any external source) to impart a curve in the entire unit as shown by example in FIGS. 5 and 6 wherein the initial composite 30 is subjected to cold bending to obtain the curved composite 38. The temperature at which cold bending is carried out is a function of the geography and location where the method is practiced, as ambient temperatures may vary based on geography. In certain embodiments, cold bending may be carried out at an environmental temperature (i.e. in an environment in which the air temperature) is greater than room temperature, e.g. a temperature of from 25 to 80° C., without departing from the scope of the subject disclosure. As readily understood in the art, use of such temperatures is still considered cold bending as distinguished from hot bending, which typically involves temperatures in excess of 500° C. In certain embodiments, “cold bending” refers to a method of bending the initial composite at a temperature well below the softening temperature of the metal frame and/or the glass panel. It should also be understood that the temperature at which cold bending is conducted refers to the temperature of the air in the environment in which the initial composite is bent, and does not mean that the initial composite is directly heated to such a temperature.

Methods of cold bending are generally known in the art. For example, in one embodiment, cold bending is carried out via a cantilevered beam assembly in which one edge of the initial composite is fixed and an opposite edge is subjected to a bending force. The force utilized to bend the initial composite can be, for example, pneumatically applied, hydraulically applied, or applied via other suitable techniques. Typically, the bending force is applied to one end of the initial composite, and may be repeated at each end of the initial composite, depending on the desired shape and configuration of the curved composite. Alternatively, the bending force may be applied to only one corner of the initial composite while holding the other corners of the composite fixed in a plane (corner clamping). In yet other alternatives, two edges of the initial composite may be fixed, and the free corner may be bent.

The structural durability of the silicone sealant 36 of the curved composite 38 is related to the relative thicknesses of the metal frame 32 and the silicone sealant 36 as measured in a direction from the metal frame through the silicone sealant 36 and glass panel 34 that is perpendicular to the face of the glass panel, as shown in FIGS. 1-3. The frame thickness 48 is therefore the dimension of the frame 32 in a direction perpendicular to the length and width of the frame. The sealant thickness 50 refers to the dimension of structural sealant 36 provided between structurally bonded surfaces or substrates to fill a joint opening between the two surfaces or substrates. Particularly, the thickness is the minimum structural sealant dimension between structurally bonded substrates, i.e. when adhesion surfaces of two substrates are not parallel, the thickness refers to the minimum dimension between those surfaces. The required sealant thickness is dependent on the joint opening bite. The joint opening bite refers to the effective structural contact dimension of the structural sealant that through its adhesion to the substrates transfers an applied load from a glass lite or panel to a metal framing system, i.e. the bite is the dimension of the contact of the structural sealant with a substrate. The required sealant thickness may also depend on the interaction of the structural sealant modulus with the primary stress (usually from an applied lateral load) and with other secondary loads such as those resulting from differential thermal movement between a metal framing system and a structurally glazed glass lite or panel. A conventional cold bent glass unit typically has, for example, a thickness ratio of the thickness of the metal frame to the thickness of the sealant of 12.5 at a given bending deflection of the conventional cold bent glass unit. In contrast, the curved composite has a thickness ratio of the metal frame to silicone sealant (the “thickness ratio”) of less than 10, alternatively less than 9.5, alternatively less than 9, alternatively less than 8.5, alternatively less than 8, alternatively less than 7.5, alternatively less than 7, alternatively less than 6.5, alternatively less than 6, alternatively less than 5.5, alternatively less than 5, alternatively less than 4.5, alternatively less than 4, at the same deflection. Surprisingly, the lower the thickness ratio, the lower the peak strain in the silicone sealant which decreases sealant creep and sealant tear. In turn, the peak strain may be used to predict the durability (in years) of the silicone sealant in the curved composite.

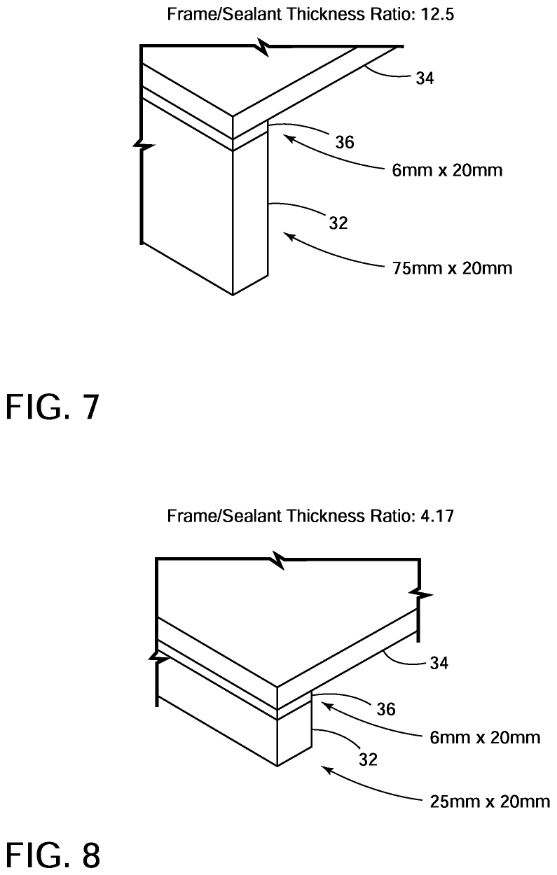

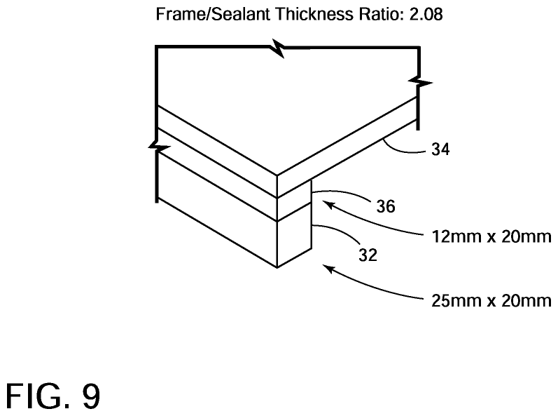

For example, a 914.4 mm×1524 mm×12 mm glass panel bonded on a 75 mm×20 mm aluminum frame with a 6 mm×20 mm layer of silicone sealant was modeled as shown in FIG. 7. This baseline composite design has thickness ratio of the metal frame to silicone sealant of 12.5. The curved composite was subjected by modeling (finite element analysis) to cold bending on both short edges at 40 mm deflection, and the resulting peak strain in the silicone sealant was calculated at 48.86%. This level of strain in the silicone sealant will not likely cause immediate failure of the silicone sealant after the cold bending process, but the predicted durability is only 1.9 years before tear failure of the silicone sealant may appear. By reducing the thickness of the metal frame to 25 mm as shown in FIG. 8, the thickness ratio was decreased to 4.17 and the peak strain decreased to 29.41%. By also increasing the thickness of the silicone sealant to 12 mm as shown in FIG. 9, the thickness ratio was further decreased to 2.08 and the peak strain decreased to 22.8%. The decrease in peak strain resulted in a significant increase in the predicted durability to 8.8 and 14.8 years, respectively, which was an improvement in predicted durability of a magnitude in the range of 4.6 to 7.8. These results are summarized in Table 1 below.

TABLE 1
Comparison of Different Frame and Sealant Design
with Same Cold Bent Glass at 40 mm Bending

| | | | | | Expected |
|---|---|---|---|---|---|
| | Metal | Silicone | | Peak | Silicone |
| | Frame | Sealant | | Strain in | Sealant Life |
| | Thickness | Thickness | Thickness | Silicone | before Tear |
| Design | [mm] | [mm] | Ratio | Sealant | [Years] |
| Baseline | 75 | 6 | 12.5 | 48.86% | 1.9 |
| Design | | | | | |
| Improved | 25 | 6 | 4.17 | 29.41% | 8.8 |
| Design 1 | | | | | |
| Improved | 25 | 12 | 2.08 | 22.80% | 14.8 |
| Design 2 | | | | | |

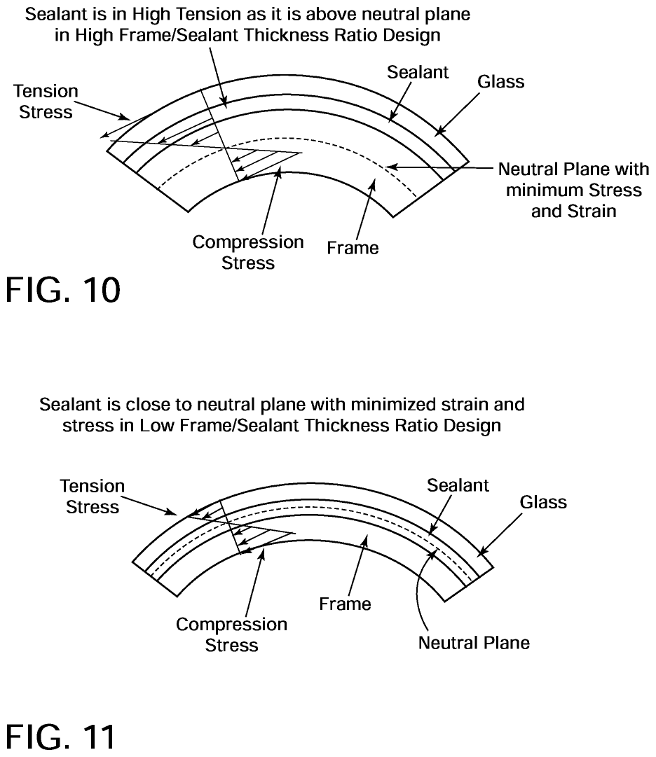

It is believed that the thickness ratio of the metal frame to the silicone sealant is significant to the strain distribution and durability of the curved composite due to its effect on the location of the neutral plane in the curved composite. The neutral plane is a conceptual, imaginary plane within a structure that is stress-free under loading. The neutral plane thereby separates compression and tension regions. When the thickness ratio of the metal frame to the silicone sealant is high (e.g. above 10), the neutral plane is located within the metal frame as shown in FIG. 10. In this case, the silicone sealant is above the neutral plane and is subjected to tension stress. If the thickness ratio of the metal frame to the silicone sealant is lowered, the neutral plane shifts from a location within the metal frame to a location within the layer of silicone sealant as shown in FIG. 11. When the neutral plane is within the silicone sealant, the silicone sealant is subjected to minimal tension and compression forces on either side of the neutral plane.

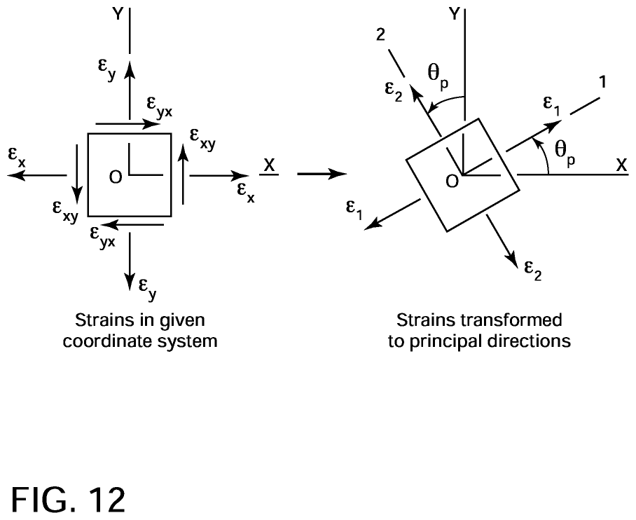

Thus, the peak maximum principal strain in the silicone sealant of the curved composite increases with thickness of the metal frame and decreases with thickness of the silicone sealant, for a given amount of cold bend deflection imparted upon the curved composite. The peak strain is also dependent upon the dimensions of the glass panel, and the type of metal frame (i.e., whether the metal frame is solid or hollow). The definition of maximum principal strain in a simple plane strain state is shown in FIG. 12 and is represented by the following Equation (1):

$${ε}_{1} = \frac{{ε}_{x} + {ε}_{y}}{2} + \sqrt{{( \frac{{ε}_{x} - {ε}_{y}}{2} )}^{2} + {( \frac{{γ}_{xy}}{2} )}^{2}}$$

where ε₁ is the maximum principal strain, εₓ is the strain in the x-axis, ε_{y} is the strain in the y-axis, and γ_{xy} is the shear strain. The peak maximum principal strain is the highest value (of maximum principal strain) in the whole structure.

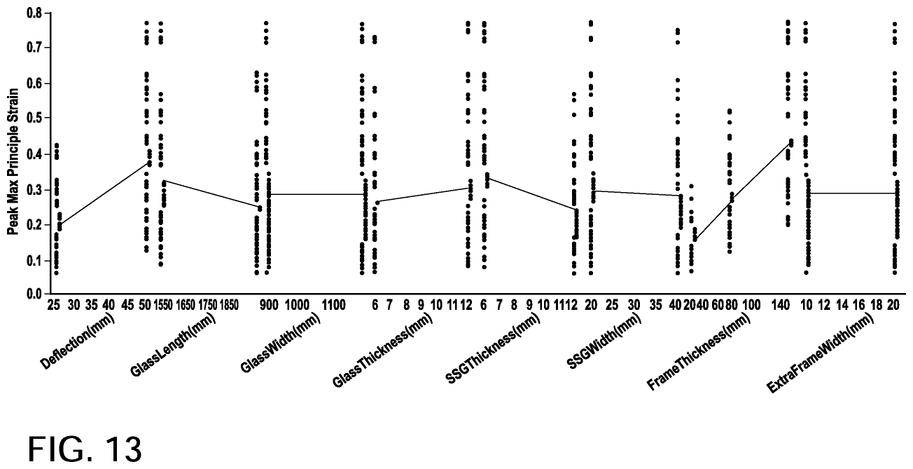

An optimized design formula was established by conducting a simulation-based DOE study. The parameters used in this study are summarized in Table 2 below. It was surprisingly found that in addition to the level of cold bend glass deflection, thicknesses of both the metal frame and the silicone sealant had the most significant effect on the peak strain in the sealant in the cold bent glass operation. The peak maximum principal strain increased with thickness of the metal frame (i.e., peak maximum principal strain was directly proportional to the thickness of the metal frame) and decreased with thickness of the silicone sealant (i.e., peak maximum principal strain was inversely proportional to the thickness of the silicone sealant), as shown in the main effect plot of FIG. 13 for a curved composite with a solid metal frame. This is consistent with the near neutral plan design concept discussed above. Therefore, a low thickness ratio is more desirable for curved composites.

TABLE 2
Cold Bent Glass Design Range Used
in Design Formula Development

| Parameter | Range |
|---|---|
| Sealant Thickness [mm] | 6, 12 |
| Frame Thickness [mm] | 25, 75, 150 |
| Frame/Sealant Thickness Ratio (Calculated) | 2-25 |
| Sealant Width [mm] | 20, 40 |
| Extra Frame Width in Comparison to Sealant Width | 10, 20 |
| [mm] | |
| Frame/Sealant Width Ratio (Calculated) | 1.25-2 |
| Glass Deflection [mm] | 25, 50 |
| Glass Length [mm] | 1524-1981.2 |
| | (100-130%) |
| Glass Width [mm] | 914.4-1188.72 |
| | (100-130%) |
| Glass Thickness [mm] | 6, 12 |

The peak strain in the silicone sealant for a curved composite with a solid metal frame subjected to cold bending may thus be calculated according to the following Equation (2):

$$Peak Strain = 20.97 \% + 0.74 \% \times Deflection [ mm ] - 0.017 \% \times Glass Length [ mm ] + 0.64 \% \times Glass Thickness [ mm ] + 0.23 \% \times Frame Thickness [ mm ] - 1.48 \% Sealant Thickness [ mm ] - 0.05 \% \times Sealant Width [ mm ]$$

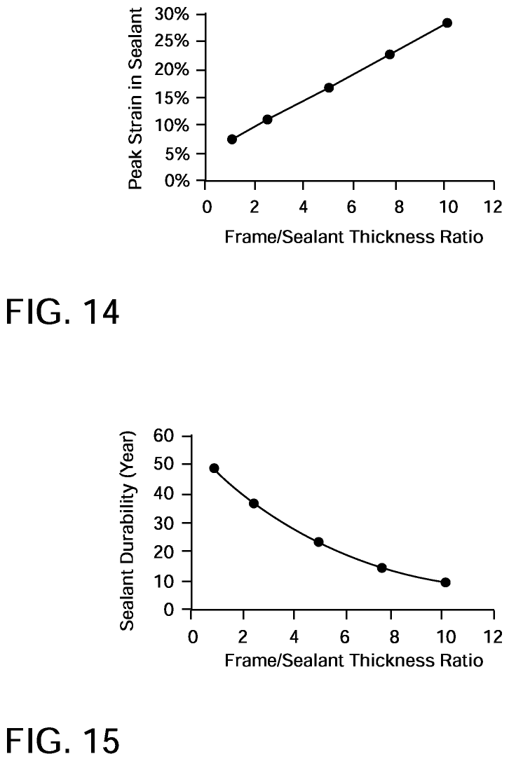

Based on Equation 2 above, the durability of the silicone sealant in the curved composite can be calculated through a strain-durability relationship established for the silicone sealant, as shown in Tables 3-5 below as well as FIGS. 14 and 15. For example, in a curved composite with a solid aluminum frame, a length of the glass panel of 1524 mm, a width of silicone sealant of 20 mm, a thickness of the silicone sealant of 10 mm, and a thickness of the glass panel of 6 mm, at 30 mm deflection, the typical thickness ratio is predicted to be lower than 4 in order to achieve 30+ year durability, and lower than 10 for 10+ year durability.

TABLE 3
Calculation of Sealant Durability based on Peak Strain Prediction

| | | | Peak Strain |
|---|---|---|---|
| | Value | Strain Coefficient | Component |
| Design Constant | | 20.97% | 20.97% |
| Deflection [mm] | 30 | 0.74% | 22.20% |
| Glass Length [mm] | 1524 | −0.017% | −25.91% |
| Glass Thickness [mm] | 6 | 0.64% | 3.84% |
| Frame Thickness [mm] | 25 | 0.23% | 5.75% |
| Sealant Thickness [mm] | 10 | −1.48% | −14.80% |
| Sealant Width [mm] | 20 | −0.05% | −1.00% |

| | |
|---|---|
| Peak Max Principle Strain | 11.05% |
| Sealant Life Prediction (Years) | 37.4 |

TABLE 4
Peak Strain in Sealant*

| Frame Sealant Thickness Ratio | Peak Max Principal Strain |
|---|---|
| 1.0 | 0.07602 |
| 2.5 | 0.11052 |
| 5.0 | 0.16802 |
| 7.5 | 0.22552 |
| 10.0 | 0.28302 |

*see also FIG. 14

TABLE 5
Sealant Durability

| Frame Sealant Thickness Ratio | Sealant Durability (Years) |
|---|---|
| 1 | 49.08223992 |
| 2.5 | 37.36908495 |
| 5 | 23.72243576 |
| 7.5 | 15.05934543 |
| 10 | 9.559890347 |

*see also FIG. 15

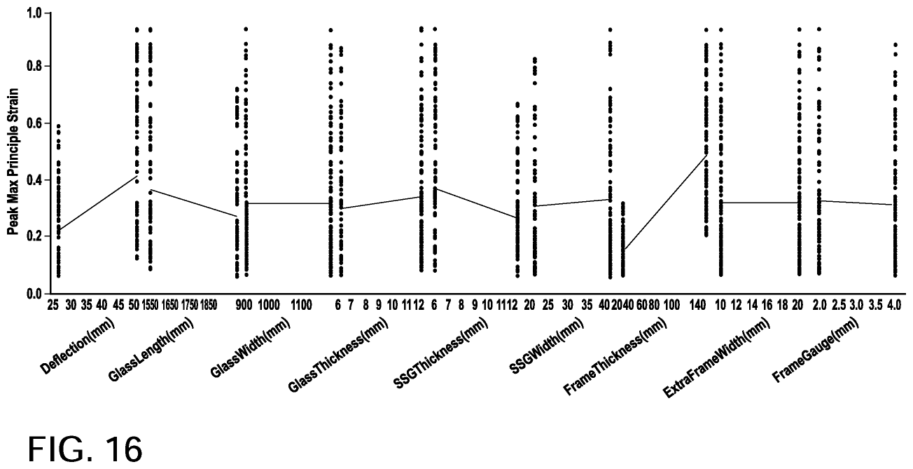

An optimized design formula for a curved composite where the metal frame was hollow was also established by conducting a simulation-based DOE study, as shown in the main effect plot in FIG. 16. Similarly, it was observed that the peak strain in the silicone sealant mainly increased with thickness of the metal frame and decreased with thickness of the silicone sealant. This result further confirmed that low thickness ratios are desirable for cold bend glass. It was also found that width of the glass panel, extra width of the metal frame, and gauge of the metal frame had a very small effect on peak strain, and therefore these factors were not considered in the design formula. The peak strain for hollow metal frame applications may thus be calculated according to the following Equation (3):

$$Peak Strain = 21.76 \% + 0.77 \% \times Deflection [ mm ] - 0.02 \% \times Glass Lenght [ mm ] + 0.67 \% \times Glass Thickness [ mm ] + 0.27 \% \times Frame Thickness [ mm ] - 1.79 \% Sealant Thickness [ mm ] + 0.12 \% \times Sealant Width [ mm ]$$

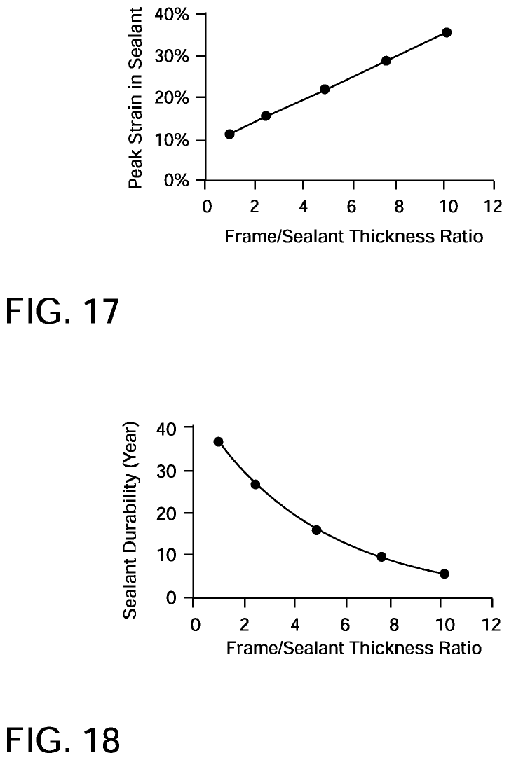

Based on Equation 3 above, the durability of the silicone sealant joint can be calculated through a strain-durability relationship established for the silicone sealant, as shown in Tables 6 and 7 below as well as FIGS. 17 and 18. For example, in a curved composite with a hollow aluminum frame, a length of the glass panel of 1524 mm, a width of the silicone sealant of 20 mm, a thickness of the silicone sealant of 10 mm and a thickness of the glass panel of 6 mm, at 30 mm deflection, the typical thickness ratio is predicted to be lower than 2 for 30+ year durability, and lower than 7 for 10+ year durability.

TABLE 6
Peak Strain in Sealant*

| Frame Sealant Thickness Ratio | Peak Max Principal Strain |
|---|---|
| 1 | 0.11172 |
| 2.5 | 0.15222 |
| 5 | 0.21972 |
| 7.5 | 0.28722 |
| 10 | 0.35472 |

*see also FIG. 17

TABLE 7
Sealant Durability

| Frame Sealant Thickness Ratio | Sealant Durability (Years) |
|---|---|
| 1 | 37.01636666 |
| 2.5 | 26.8774772 |
| 5 | 15.76569153 |
| 7.5 | 9.247781242 |
| 10 | 5.424529443 |

*see also FIG. 18

A case study was further performed to test the efficacy of the obtained design equations. Specifically, a cold bent glass design was evaluated using Equation (3) and compared with the durability/sealant failure for this design observed in the field. The effective thickness of the metal frame was 130 mm, the metal frame was hollow, the thickness ratio was 16.25, the glass panel had dimensions of 1535 mm×1632 mm, and the curved composite was subjected to a deflection of 23.9 mm. The peak strain was calculated by Equation (3) to be 52.37%. The corresponding durability of the silicone sealant was estimated to be 1.4 years. This durability estimate was close to the actual service life of this design reported from the field, which was approximately 1 year. These results are summarized in Table 8 below.

TABLE 8
Silicone Sealant Durability and Peak Strain Prediction
by Equation (3) for an Actual Design

| | | Strain | Peak Strain |
|---|---|---|---|
| | Value | Coefficient | Component |
| Design Constant | | 22.76% | 22.76% |
| Deflection [mm] | 23.9 | 0.77% | 18.40% |
| Glass Length [mm] | 1535 | −0.03% | −26.10% |
| Glass Thickness [mm] | 20 | 0.67% | 13.40% |
| (not including spacer) | | | |
| Frame Thickness [mm] | 130 | 0.27% | 35.10% |
| Sealant Thickness [mm] | 8 | −1.79% | −14.32% |
| Sealant Width [mm] | 26 | 0.12% | 3.12% |

| | |
|---|---|
| Peak Max Principle Strain | 52.37% |
| Sealant Life Prediction (Years) | 1.4 |

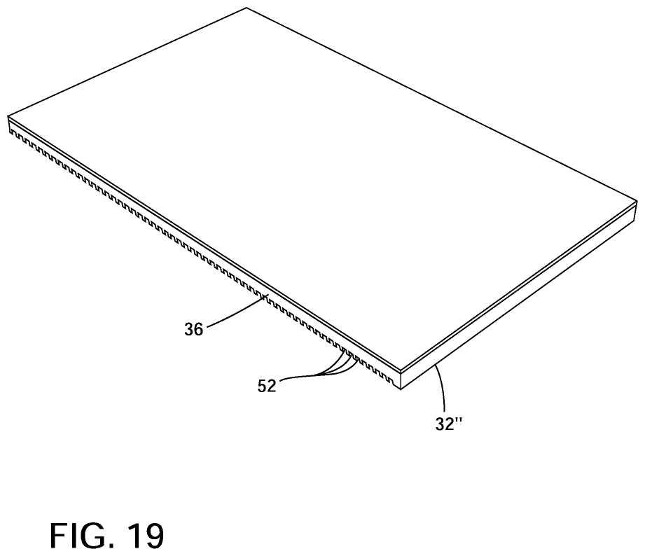

In certain embodiments, the peak strain may also be reduced by providing a plurality of substantially parallel grooves 52 in the metal frame 32″, the grooves being oriented in a direction transverse to the direction of cold bending of the curved composite. The grooves 52 may be located on a side of the metal frame 32″ opposite the silicone sealant 36 as shown in FIG. 19. Keeping all other factors constant (e.g. thicknesses of the metal frame and silicone sealant, dimensions of the glass panel, bending deflection), the presence of the grooves may reduce the peak strain by 8 percentage points. For example, the peak strain may be reduced from 34.5% (metal frame with no grooves) to 26.5% (metal frame having grooves). The predicted durability of the silicone sealant thereby increases from 5.8 years to 11 years. The peak strain in the silicone sealant for a curved composite with a solid metal frame including grooves may be calculated according to the following Equation (4):

$$Peak Strain = 5.29 \% - 0.4 \% \times Groove Depth [ mm ] + 0.001 \% \times Groove Spacing [ mm ] + 0.671 \% \times Deflection [ mm ]$$

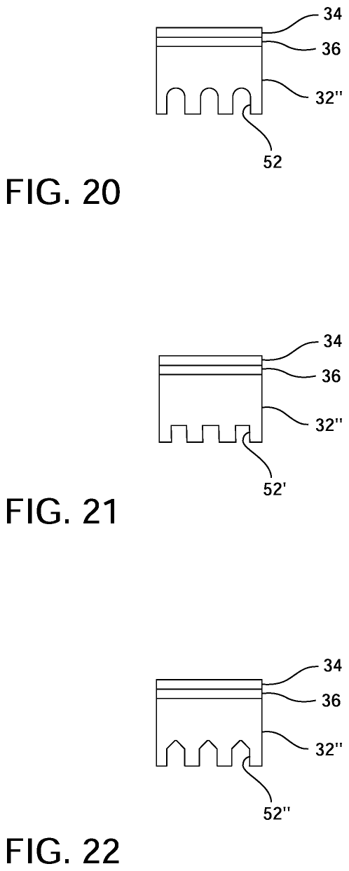

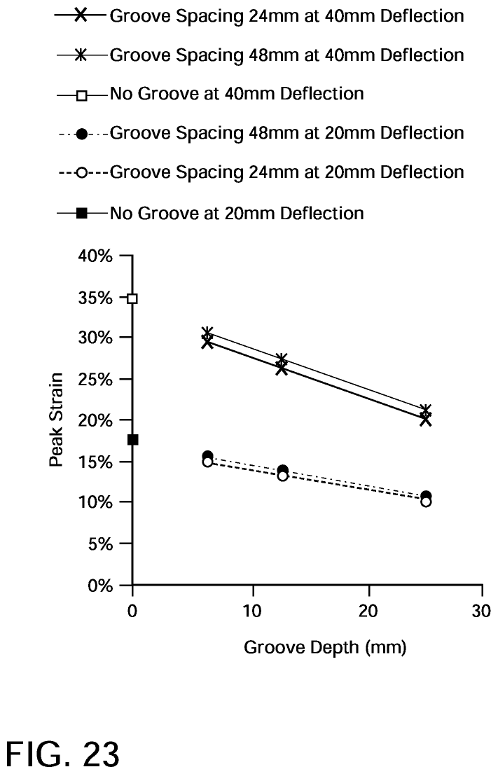

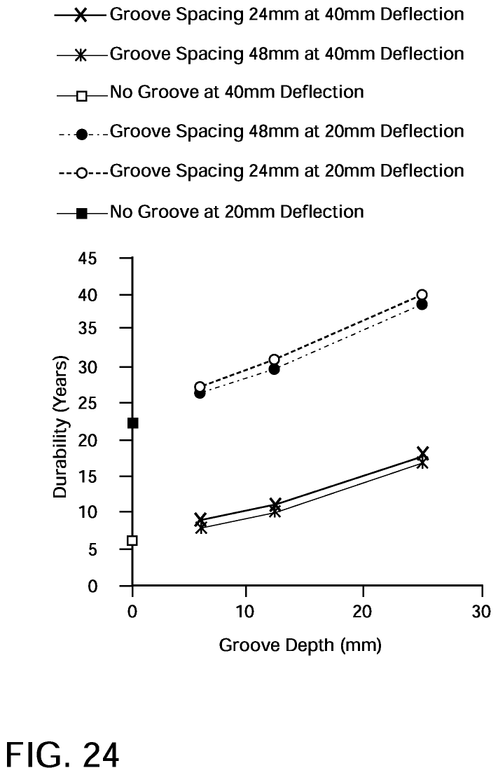

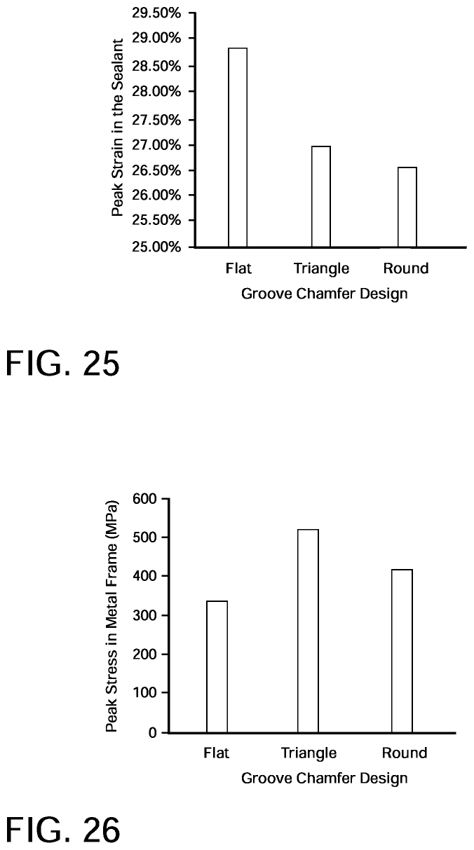

The groove depth is a distance from a groove opening in the surface of the frame to the bottom of the groove opposite the groove opening, and the groove spacing is a distance between two adjacent grooves.
The grooves may have one of a variety of configurations that affects the level of peak strain, such as but not limited to a round groove chamfer 52 shown in FIG. 20, a flat groove chamfer 52′ shown in FIG. 21, and a triangular groove chamfer 52″ shown in FIG. 22. A further parametric study was carried out for a 1542 mm×914.4 mm×6 mm glass panel bonded onto a 50 mm×20 mm aluminum frame with a 6 mm×20 mm silicone sealant for these different groove patterns. As shown in FIGS. 23 and 24 and summarized in Table 9 below, under typical 20 to 40 mm cold bending deflection, the groove pattern on the aluminum frame significantly reduced the peak strain in the silicone sealant. Consequently, the durability of the curved composite was predicted to significantly improve. For example, as shown in FIGS. 25 and 26, round and triangular chamfer grooves may provide lower peak strain in comparison to flat grooves. Round chamfer grooves also advantageously provide a moderate level of stress in the metal frame during cold bending, thereby offering a balance between peak strain in the silicone sealant and peak stress in the metal frame, when compared to flat or triangular grooves. Surface grooving on the metal frame of the curved composite is therefore an effective design choice to ensure peak strain in the sealant will not cause tear failure or excessive creep.

TABLE 9
Effect of Groove Configurations and Dimensions
on Peak Strain and Durability

| | | | | Peak | | Peak |
|---|---|---|---|---|---|---|
| | Groove | Groove | Bending | Max | | Max |
| Groove | Depth | Spacing | Deflection | Principal | Durability | Stress |
| Profile | (mm) | (mm) | (mm) | Strain | (years) | (Mpa) |
| Round | 0 | 0 | 40 | 34.54% | 5.8 | |
| Round | 25 | 24 | 40 | 20.34% | 17.9 | |
| Round | 12.5 | 24 | 40 | 26.54% | 11.0 | |
| Round | 6.25 | 24 | 40 | 29.62% | 8.6 | |
| Round | 25 | 48 | 40 | 21.19% | 16.8 | |
| Round | 12.5 | 48 | 40 | 27.47% | 10.2 | |
| Round | 6.25 | 48 | 40 | 30.49% | 8.0 | |
| Round | 0 | 0 | 20 | 17.55% | 22.4 | |
| Round | 25 | 24 | 20 | 10.27% | 39.8 | |
| Round | 12.5 | 24 | 20 | 13.42% | 31.0 | |
| Round | 6.25 | 24 | 20 | 15.00% | 27.4 | |
| Round | 25 | 48 | 20 | 10.68% | 38.5 | |
| Round | 12.5 | 48 | 20 | 13.89% | 29.9 | |
| Round | 6.25 | 48 | 20 | 15.44% | 26.4 | |
| Flat | 12.5 | 24 | 40 | 28.84% | 9.2 | 337.7 |
| Triangle | 12.5 | 24 | 40 | 26.94% | 10.6 | 522 |
| Round | 12.5 | 24 | 40 | 26.54% | 11.0 | 418 |

The curved composites of this disclosure can be utilized in myriad end use applications, including residential and commercial buildings, passenger and commercial vehicles, public transportation, and any other end use applications requiring bent glass.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A method of preparing a curved structural glazing composite, said method comprising:
providing an initial composite comprising a metal frame and a glass panel with a silicone sealant disposed therebetween; and
cold bending the initial composite to give the curved structural glazing composite;
wherein a ratio of a thickness of the metal frame to a thickness of the silicone sealant is less than 10.

2. The method of claim 1, wherein cold bending is carried out without the application of heat.

3. The method of claim 1, wherein the metal frame defines an internal cavity, and wherein the ratio of a thickness of the metal frame to a thickness of the silicone sealant is less than 7.

4. The method of claim 1, wherein the ratio of a thickness of the metal frame to a thickness of the silicone sealant is less than 4.

5. The method of claim 1, wherein the metal frame and the silicone sealant are continuous about a perimeter of the glass panel and define an internal gap adjacent the glass panel.

6. The method of claim 1, wherein the silicone sealant is only disposed along a portion of the perimeter of the glass panel.

7. The method of claim 1, further comprising preparing the initial composite by sandwiching a silicone sealant composition between the metal frame and the glass panel and curing the silicone sealant composition to give the silicone sealant and the initial composite.

8. The method of claim 1, wherein the metal frame defines a plurality of substantially parallel grooves oriented in a direction transverse to the direction that the initial composite is bent, and wherein the grooves are located on a side of the metal frame opposite of the silicone sealant.

9. The method of claim 8, wherein the grooves are configured to reduce peak maximum principal strain in the silicone sealant by at least 8 percentage points.

10. The method of claim 1, further comprising calculating a correlation between the peak maximum principal strain and the durability of the silicone sealant of the curved structural glazing composite.

11. The method of claim 10, wherein the peak maximum principal strain is less than 35%.

12. A curved structural glazing composite formed in accordance with the method of claim 1.

13. A building comprising the curved structural glazing composite of claim 12.

14. A curved structural glazing composite, comprising:
a metal frame and a glass panel with a silicone sealant disposed therebetween;
wherein a ratio of a thickness of the metal frame to a thickness of the silicone sealant is less than 10.

15. A building comprising the curved structural glazing composite of claim 14.
